(19) United States
(12) Patent Application Publication
(10) Pub. No.: US 2017/0228507 A1
(43) Pub. Date: Aug. 10, 2017

(54) AUTOMATIC DISEASE DIAGNOSES USING LONGITUDINAL MEDICAL RECORD DATA

(71) Applicant: Icahn School of Medicine at Mount Sinai, New York, NY (US)

(72) Inventors: Erwin BOTTINGER, New Rochelle, NY (US); Girish NADKARNI, New York, NY (US); Omri GOTTESMAN, New York, NY (US); Stephen Bartlett ELLIS, Long Island City, NY (US); Ilka HUOPANIEMI, Leipzig (DE)

(21) Appl. No.: 15/502,266

(22) PCT Filed: Jul. 31, 2015
(86) PCT No.: PCT/US2015/043318

§ 371 Date: Feb. 7, 2017

Related U.S. Application Data
(60) Provisional application No. 62/035,166, filed on Aug. 8, 2014.

(51) Int. Cl. G06F 19/00

(52) U.S. Cl. CPC G06F 19/345; G06F 19/322; G06F 19/24

(57) ABSTRACT

An example method of automated medical diagnosis includes obtaining an electronic longitudinal data set for each of a plurality of patients, where each data set includes a plurality of measurement values corresponding to a metric, where each measurement value is associated with a respective time point. The method also includes arranging the data sets into two or more clusters. Arranging the data sets includes aligning the data sets according to their respective time points, selecting a cluster center for each cluster, determining a similarity between each data set and each cluster center, assigning each data set to a particular cluster based on the similarities, and iteratively re-aligning one or more of the data sets and/or reselecting one or more cluster centers, determining an updated similarity between each data set and each cluster center, and re-assigning data sets to particular clusters based on the updated similarities until a stop criterion is met. The method also includes automatically determining a medical diagnosis for a patient based on a relationship between the patient's data set and a cluster center.

This invention was made with government support under grant number U01HG006380, awarded by the National Institutes of Health (NIH). The US government has certain rights in the invention.

### TECHNICAL FIELD

This disclosure relates to automated medical diagnoses, and more particularly to automatically making medical diagnoses using longitudinal medical record data.

### BACKGROUND

Electronic medical records (EMR) can provide a variety of clinical data collected during routine clinical care encounters. In some cases, EMR can contain a collection of longitudinal phenotypic data that potentially offers valuable information for discovering clinical population subtypes, and can potentially be used in association studies in medical research and in the prediction of outcomes in patient care. In many cases, a number of clinical parameters and laboratory tests are collected as part of routine clinical care and their results are stored in an EMR (e.g., in electronic records stored in a data warehouse). Collections of EMRs can thus represent a general patient population, and can be used for a variety of statistical analyses. As examples, routinely collected data includes systolic blood pressure (SBP), low-density lipoproteins (LDL), high-density lipoproteins (HDL), triglycerides, hemoglobin A1C (marker for diabetes and diabetes (blood glucose) control), and estimated glomerular filtration rate (eGFR; a marker of kidney function).

In the fields of medical research and clinical care, there is interest in discovering groups of similar patients with similar disease progression patterns. For example, groups of similar patients can be determined for metabolic syndromes that involve varying accumulation of obesity, hypertension, hyperlipidemia, Type 2 diabetes, coronary artery disease and chronic kidney disease (CKD). Information about each of these groups can be used to provide improved medical diagnoses of current and future patients, provide more accurate predictions of patient outcome, and improve the overall quality of clinical care. For example, in some cases, using population subtypes in association studies instead of broad disease definitions can lead to superior results. Separating differential progression patterns in the phenotypic variables can potentially discover these subpopulations. For instance, in the case of chronic and progressive diseases, an important difference between subtypes of a disease is often differential rates of progression, and models attempting to find subtypes in progressive diseases often should be able to account for this.

As an example, the prevalence of CKD currently ranges from about 10% to 15% in the United States, Europe and Asia. CKD is often associated with increased mortality, decreased quality of life, and increased health care expenditure. CKD is defined in most cases clinically by loss of kidney function as estimated by a glomerular filtration rate (eGFR) below a threshold of 60 ml/min/1.72 kg2 (normal eGFR range 90 to 120 ml/min/1.73 kg2) and/or persistent increased urinary albumin excretion lasting more than 90 days. Untreated CKD can result in endstage renal disease (ESRD) and necessitate dialysis or kidney transplantation in 2% of cases. CKD is also a major independent risk factor for cardiovascular disease, all-cause mortality including cardiovascular mortality. Approximately two thirds of CKD are attributable to diabetes (40% of CKD cases) and hypertension (28% of cases). However, CKD is also characterized by variable rates of progression with a significant proportion of patients having stable kidney function over time while some patients have rapid progression. These differential rates of progression lead to clinically relevant, interesting subtypes among patient populations. By discovering groups of similar patients with similar CKD progression, information regarding each of these groups can be used to provide improved medical diagnoses of current and future patients, provide more accurate predictions of patient outcome, and improve the overall quality of clinical care.

### SUMMARY

In general, in an aspect, an example method of automated medical diagnosis includes obtaining an electronic longitudinal data set for each of a plurality of patients, where each data set includes a plurality of measurement values corresponding to a metric, where each measurement value is associated with a respective time point. The method also includes arranging the data sets into two or more clusters. Arranging the data sets includes aligning the data sets according to their respective time points, selecting a cluster center for each cluster, determining a similarity between each data set and each cluster center, assigning each data set to a particular cluster based on the similarities, and iteratively re-aligning one or more of the data sets and/or reselecting one or more cluster centers, determining an updated similarity between each data set and each cluster center, and re-assigning data sets to particular clusters based on the updated similarities until a stop criterion is met. The method also includes automatically determining a medical diagnosis for a patient based on a relationship between the patient's data set and a cluster center.

In general, in another aspect, a system for diagnosing chronic kidney disease (CKD) includes a computing apparatus. The computing apparatus is configured to obtain an electronic longitudinal data set for each of a plurality of patients, where each data set includes a plurality of measurement values corresponding to a metric, where each measurement value is associated with a respective time point. The computing apparatus is also configured to arrange the data sets into two or more clusters, where arranging the data sets includes aligning the data sets according to their respective time points, selecting a cluster center for each cluster, determining a similarity between each data set and each cluster center, assigning each data set to a particular cluster based on the similarities, and iteratively re-aligning one or more of the data sets and/or reselecting one or more cluster centers, determining an updated similarity between each data set and each cluster center, and re-assigning data sets to particular clusters based on the updated similarities until a stop criterion is met. The computing apparatus is also configured to automatically determine a medical diagnosis for a patient based on a relationship between the patient's data set and a cluster center.

In general, in another aspect, a non-transitory computer readable medium stores instructions that are operable when executed by a data processing apparatus to perform operations for determining a permeability of a subterranean formation. The operations include obtaining an electronic longitudinal data set for each of a plurality of patients, where each data set includes a plurality of measurement values corresponding to a metric, where each measurement value is associated with a respective time point. The method also includes arranging the data sets into two or more clusters. Arranging the data sets includes aligning the data sets according to their respective time points, selecting a cluster center for each cluster, determining a similarity between each data set and each cluster center, assigning each data set to a particular cluster based on the similarities, and iteratively re-aligning one or more of the data sets and/or reselecting one or more cluster centers, determining an updated similarity between each data set and each cluster center, and re-assigning data sets to particular clusters based on the updated similarities until a stop criterion is met. The method also includes automatically determining a medical diagnosis for a patient based on a relationship between the patient's data set and a cluster center.

Implementations of this aspect may include one or more of the following features:

In some implementations, at least one of the data sets has a different number of measurement values than other data sets.

In some implementations, each cluster center includes a plurality of reference values, each measurement value associated with a respective reference time point. Determining a similarity between each data set and each cluster center can include determining similarities between measurement values of each data set to corresponding reference values of each cluster center.

In some implementations, the stop criterion includes a threshold value associated with the similarity determination.

In some implementations, aligning the data sets according to their respective time points includes aligning the data sets such that a first measurement value of each data set is aligned according to a common time point.

In some implementations, re-aligning one or more of the data sets includes shifting the time points of the one or more data sets relative to the time points of one or more other data sets.

In some implementations, the measurement values correspond to a biological metric of a particular patient.

In some implementations, each measurement value corresponds to an estimated glomerular filtration rate of a particular patient at a particular point in time.

In some implementations, the medical diagnosis includes a predicted disease state. The disease state can be chronic kidney disease.

Implementations of the above aspects may include one or more of the following benefits:

Some implementations can be used to provide improved medical diagnoses of current and future patients, provide more accurate predictions of patient outcome, and improve the overall quality of clinical care. In some implementations, a diagnosis can be automatically rendered using electronic medical records, freeing up a clinician to treat other patients instead of reviewing voluminous medical histories. As a result, implementations of the above aspects can save time and money for both patients and clinicians, and render more accurate and reliable diagnoses. Further, some implementations can be used to analyze relatively irregular data source, or data sources having data sets sparse and/or unaligned longitudinal data, and thus allow for the interpretation of disparate or non-uniformly collected data.

### DESCRIPTION OF DRAWINGS

FIGS. 1A-B show histograms of a distribution of EMRs in an example database.

FIG. 2 is a diagram of an example process for making an automated medical diagnosis.

FIG. 3 is a diagram of an example process for arranging data sets into clusters.

FIG. 4 shows example results of clustering data sets.

FIG. 5 is a chart showing slopes of individual trajectories in example clusters.

FIG. 6 shows example results of clustering data sets using multiple variables.

FIG. 7 is a diagram of an example computer system.

FIG. 8 is a diagram of another example process for making an automated medical diagnosis.

### DETAILED DESCRIPTION

Implementations for automatically making medical diagnoses using longitudinal medical record data are described below. In example implementations, an unsupervised machine learning technique takes longitudinal data of one variable from all patients and clusters them to population subtypes of which some are healthy and some turn out to be disease subtypes. In some cases, the diagnosis technique utilizes as much longitudinal data as possible, such that information from a broad array of patients is considered before making each diagnosis. One or more of the implementations below may provide particular benefits. For example, in some implementations, using the population subtypes as disease labels in association studies may be superior to the standard approaches of assigning disease labels from EMR data. In some cases, using population subtypes and their temporal progression patterns may also lead to improved performance in risk prediction.

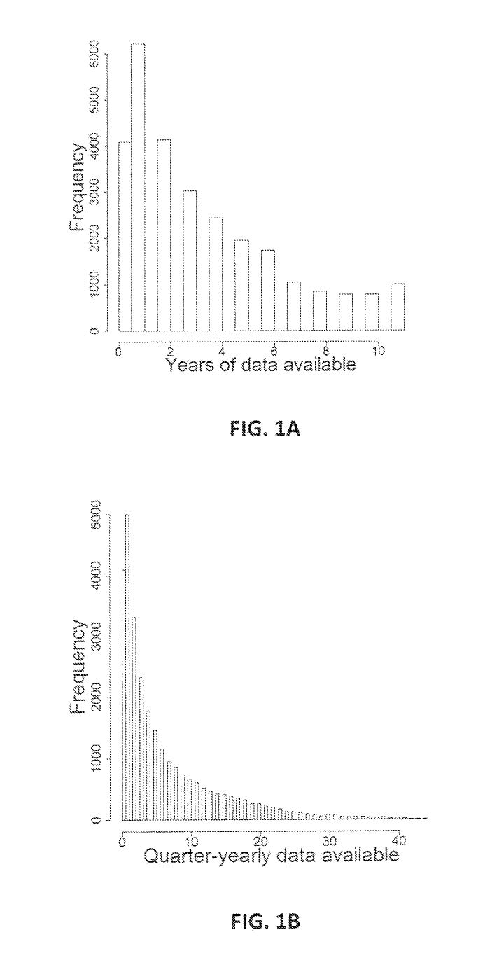

In many cases, EMRs from medical examinations may relatively irregular and observational data sources, as opposed to randomized controlled trials used in designed disease or drug studies. In the latter, data might be collected at regular intervals under tight control of the investigators and disease onset times (e.g., “first” time points) are clearly recorded. In analyzing EMR data, however, there are two major challenges: (a) sparse data (e.g., large or otherwise significant proportions of missing data) and (b) unaligned nature of the longitudinal data. As an example, a particular medical database might have a longitudinal data collection from a period of eleven years, and the aim may be to use quarterly (i.e., every three months) median values of examination measurements to reach a clinically relevant resolution. However, the number of years from which there is data from each individual patient can vary greatly. As an illustrative example, FIGS. 1A-B show histograms of a distribution of EMRs in an example database. As shown in FIG. 1A, only a minority of patients in this example database have a full coverage of data from eleven years. Similarly, as shown in FIG. 1B, few patients in this example database have quarterly data available over the span of eleven years. In this particular example, multiple measurements from the same quarter-year have been converted into one median value. Although an example distribution of data sets is shown, this is merely an illustrative example. In practice, data sets can be distributed in different ways, depending on the implementation. Likewise, although the above example combines measurements from the same binning period into a single median value, other techniques can be used (e.g., finding the mean of several measurements in the same period, discarding additional measurements from the same period, and so forth).

When a large portion of the data is missing, imputation or removing samples or rows with missing data might not be sensible options, as very few samples might remain. Further, another problem in analyzing such data is that in many cases, there is no clear initial time point signifying the onset of disease (e.g., the “first” time point, or t=0). Since patients have their first visit to a certain hospital at highly varying phases of progression of a disease, the first hospital visit with recorded data cannot always be used as the initial time point. Further, in many cases, using diagnostic criteria (such as determining the first eGFR<60 measurement in diagnosing CKD) to fix the initial time point might not give adequate results in subtype modeling. Furthermore, although many patients do not yet have any major disease, it may still be desirable to include some or all of these patients in the analysis. Without a known start point, standard clustering techniques cannot be used reliably, since time points do not match between patients.

Here, we describe example implementations of a making medical diagnoses using Bayesian clustering and alignment. Various implementations of this technique are capable of identifying subpopulations of patients from a longitudinal data set and overcoming the challenges of sparsity and unaligned nature of the data. Implementations of this technique align together time-series profiles in different phases of patients' disease progressions in order to find clusters of similar progression patterns. Implementations of this technique enable the construction of models using samples with a large or otherwise significant proportion of their time points missing. As a result, implementations of this technique can use a large proportion of the patients an available database for modeling. Further, implementations of this technique can also be used for clustering short time-series, since different rates of progression can be readily identified.

In addition to making medical diagnoses, implementations of this technique can be used to visualize the progression patterns present in the large patient populations. Further, in some implementations, the cluster labels of each cluster can be used as traits in association studies with, for example, International Statistical Classification of Disease codes (e.g., ICD9 codes), laboratory, medication or genomic data. In many cases, meaningful progression subtypes (e.g., CKD progression subtypes) can be identified using this technique.

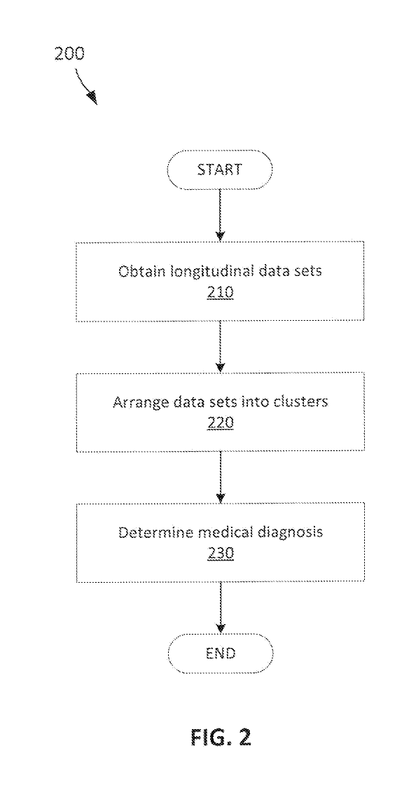

An example process 200 for making an automated medical diagnosis is shown in FIG. 2. Process 200 begins by obtaining longitudinal data sets for each of several patients (step 210). In some implementations, each longitudinal data set can include multiple measurements value corresponding to a particular metric (e.g., the results of a particular type of medical test or assay). As examples, a measurement value can indicate a patient's systolic blood pressure (SBP), low-density lipoproteins (LDL), high-density lipoproteins (HDL), triglycerides, hemoglobin A1C, or estimated glomerular filtration rate (eGFR), among other biological metrics. As other examples, a measurement value can indicate demographic information or other information pertaining to the patient (e.g., location, age, gender, ethnicity, and so forth). As other examples, a measurement value can indicate the answer to a question (e.g., an indication if a patient meets a particular criterion, for example if the patient has been previously diagnosed with a particular disease). In some implementations, a measurement value can be a value in a continuous range, a binary value (e.g., true/false, yes/no, or an indication of gender), or value from a discrete set of possible values (e.g., an indication of a particular category, or a particular integer score or metric determined using a scoring rubric). In some implementations, each measurement value can also include information regarding when that measurement value was observed. As an example, a data set could include several measurement values, where each measurement value is associated with a respective time point. Collectively, the data set can form a “trajectory” that describes the patient's historical measurements over a period of time.

In some cases, longitudinal data sets can be obtained from electronic medical records (EMRs). As an example, medical information regarding a patient can be stored, maintained, and retrieved from one or more computer systems (e.g., client computers, server computers, distributed computing systems, and so forth) or other devices capable of retaining electronic data. In an example implementation, medical information regarding a patient can be transcribed into an EMR, transmitted to a computer system for storage, revised over time (e.g., to add, delete, or edit data), and retrieved for review. In some implementations, multiple EMR can be stored in this manner in the form of a database. As an example, multiple EMRs, each referring to a different patient, can be transmitted to a computer system for storage, then individually revised or retrieved for review at a later point in time.

As noted above, in some implementations, each patient may have a different medical examination history. For example, patients may have differences in the number of medical examinations they have undergone, differences in frequency of the medical examinations, differences in the span of time during which they have undergone medical examinations, and so forth. Further, the amount of data that is available for each patient may differ. For example, some patient records may include more data than others due to differences in data collection and retention policies (e.g., due to different policies from different clinics, or changes to a clinic's data collection and retention policies over time). Accordingly, each patient's data set can likewise differ. In some implementations, some of the data sets may have a different number of measurement values than other data sets. For example, in some cases, some patients may have undergone more medical tests than others, and may have more measurement values than others. In implementations, some of the data sets may span a different length of time than other data sets. As an example, one patient may have undergone medical tests over the course of five years, while another patient may have under gone medical tests over the course of only one year; thus, the first patient's data set might span five years, while the second patient might span only one year. In some implementations, some data sets can have measurement values over a continuous period of time (e.g., every day, week, month, quarter, year, and so forth). In some implementations, some data sets can have measurement values sporadically over a particular period of time (e.g., measurements values that are separated by arbitrary amounts of time).

Different numbers of data sets can be obtained, depending on the implementation. In some implementations, all available data sets can be obtained (e.g., all available data sets in a particular database or system). In some implementations, a subset of all available data sets can be obtained. In some cases, data sets can be filtered, such that only data sets that satisfy particular criteria are obtained. As examples, data sets can be filtered by the type of measurement data contained within it, the number of measurement values, the span of time encompassed by the data set, demographic information regarding each patient (e.g., age, location, gender, ethnicity, and so forth), or any other filtering criterion. In some implementations, particular data sets can be removed from consideration manually by a user (e.g., in accordance with particular exclusion criteria or arbitrarily).

After data sets are obtained, the process 200 continues by arranging the data sets into several clusters (step 220). Clusters are groups of data sets that have similar characteristics. For example, data sets in a particular cluster might each have trajectories that are relatively similar to each other, while having trajectories that are relatively different from those of data sets in other clusters. Thus, data sets in a cluster represent patients that have a similar disease progression.

Data sets can be arranged into different numbers of clusters, depending on the application. For example, in some cases, data sets can be arranged into two, three, four, or more clusters. In some implementations, the number of clusters can be pre-determined. For example, a pre-determined number of clusters can be used to represent a known number of different possible disease states, a known number of disease progression patterns, or an otherwise optimal number of cluster (e.g., as determined using a cluster number determination technique). In some implementations, the number of clusters can be determined during the course of the clustering. For example, in some implementations, a particular number of clusters can be initially used clustering; this number can then be changed (e.g., increased or decreased) during clustering to accommodate different patterns that are discovered during clustering. Further detail regarding clustering is described below.

After the data sets are arranged into several clusters, the process 200 continues by determining a medical diagnosis for a particular patient based on a relationship between that patient's data set and a particular one of the clusters (step 230). As described above, clusters are groups of data sets that have similar characteristics. Thus, data sets in a cluster represent patients that have a similar disease progression. If information is known about some of the patients in a particular cluster, that information might also be applicable to other patients of that cluster. For example, some patients in a particular cluster may have been previously diagnosed with a particular disease, and thus, their data set represents the progression of that disease over a period of time. If a significant number (e.g., a statistically significant number) of these types of patients are in a particular cluster, it can be inferred that other patients in this cluster might also have the same disease. Thus, the diagnoses of a subset of the patients (either using implementations of this technique or using other diagnosis techniques) can be used to diagnosis other patients. Further, as each patient in the cluster may at a different point in disease progression, this technique can be used to predict each patient's present disease progression and to estimate their future disease progression.

As described above, data set can be arranged into several clusters based on similarities between each of the data sets. Clustering is a statistical technique in which observations (e.g., data sets from patients) are partitioned to sets of similar observations (e.g., clusters). This can be accomplished by assigning “cluster centers” to each cluster, where each cluster center defines a particular classification value or collection of values for its respective cluster. Data sets have similar characteristics as each cluster center are then assigned to the respective cluster. For example, for EMR data that contains trajectories of measurement values, each cluster center can be a reference trajectory of measurement values. Data sets have similar trajectories as a particular cluster center can be assigned to the respective cluster.

In some implementations, clustering includes iterating between assigning the observations to clusters and updating the cluster centers. As described above, in some cases, the number of clusters to be sought can be defined a priori as a model parameter. As described, in EMR data, there is often no well-defined start point. That is, a patient's first visit to the hospital does not always correspond to the onset of a disease. Thus, the start point can be iteratively determined from the data sets as well. As an example, the start point of each patient's trajectory can be iteratively aligned to the clusters' trajectories. In this manner, the start point parameter might not have a directly practical interpretation (e.g., a time of disease onset), but enables the alignment of the unaligned time-series so that coherent progression patterns can be found.

In an example implementation, each patient i (i=1:I, where I is the total number of patients), is associated with a data vector xᵢ of T time points so that the first element is the first visit to the clinic. As noted above, in general, many elements of the data vector xᵢ may be missing. In an illustrative example, T=44, and I=10539. This clustering model can be based on a multivariate mixture of Gaussians with two modifications. Firstly, as the data vectors xᵢ may have missing values, the samples (i.e., patients corresponding to the data vectors xᵢ) are assigned to clustered such that the likelihood of the sparse time-series with respect to the corresponding cluster center trajectory is evaluated using only the time points with non-missing data. Secondly, the longitudinal data vectors are temporally aligned. In some implementations, M different starting points are allowed in each cluster; as a result, each cluster center is of length (T+M−1), using M=20. The alignment is done jointly with clustering by additionally evaluating the likelihood of the time-series in each possible start point in each cluster. A Bayesian generative model is used because when sampling the cluster assignments and alignments of time-series of varying lengths and with many missing time points, some of the time points of the cluster trajectories may not have any data currently assigned to them. In that case, priors can determine the values of those cluster trajectory points.

By following the Bayesian formalism, we assume a generative model that has generated the observed data. The model can then be used to learn the model parameters from the data; the relevant model parameters here are cluster assignments k and learned start points m for each patients and the cluster trajectories (i.e., cluster centers) θₖₜ that can be viewed as average progression patterns.

The generative model is:

xᵢₜ=N(θₖ₍ₜ₊ₘ₋₁₎,σ),

k˜multinominal(π),

m˜multinomial(β),

π˜Dirichlet(α),

θₖₜ˜N(H,σ₂).

We thus assume that the observed data has been generated by the following mechanism: patient i comes from cluster k that is randomly chosen from a multinomial distribution of cluster weights π and the patient has the first visit to a hospital at phase m in the cluster trajectory, randomly chosen from a multinomial distribution of prior weights β. The data points in the time-series xᵢₜ are generated from a Gaussian distribution, where the cluster trajectory point θₖ₍ₜ₊ₘ₋₁₎ is the mean and σ is the standard deviation. Cluster weights π are determined by a Dirichlet distribution with a base measure α. The cluster centers θₖₜ come from a Gaussian distribution with hyperpriors H and σ₂.

Particular values can be selected for each of the above described parameters. As an example implementation, the σ is a fixed parameter set to a tight value σ=1 to get coherent clusters. H is set as the average of all measurements in the dataset. The σ₂=30 is set as a loose value to enable the modeling of a wide range of cluster trajectories, α=1. The first five and last five values of the prior weights of the alignments β are set to a low value and all the middle values to a uniform high value in order to improve the mixing in the sampling of the model (that trajectories would not get stuck in the beginning or end). Although example values are described above, these are merely examples. In practice, other values can be used, depending on the implementation. In some implementations, Gibbs sampling can be utilized for approximate inference (iteratively). The Gibbs equations can be derived from the generative model.

When a clustering configuration has been reached, the cluster assignments can be used for making inference of the data. The progression patterns can be visualized by plotting the data divided into clusters together with the alignments.

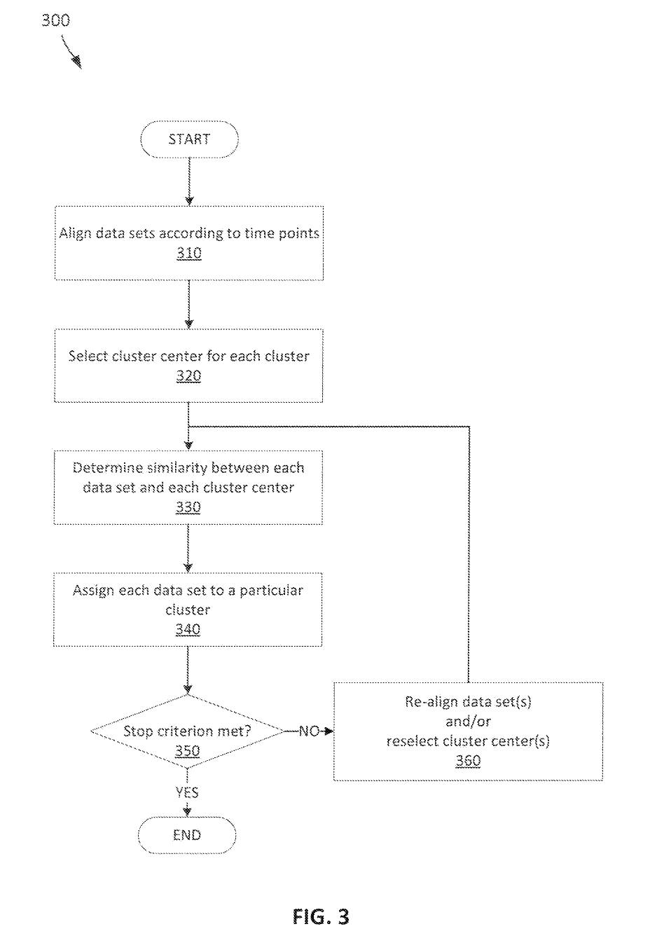

An example process 300 for arranging data sets into clusters is shown in FIG. 3. The process 300 can be performed, for example, as a part of step 220 shown in FIG. 2. The process 300 begins by aligning the data sets according to time points (step 310). As described above, each data set includes trajectories of several measurement values and time points. In an example, the data sets can be aligned such that the first time point (t=0, representing the first measurement value that was obtained for that patient) of each are aligned. In this manner, measurements from each patient's first clinical visit are aligned for comparison. In some implementations, however, measurements can be aligned differently (e.g., arbitrarily or according to a priori information). As noted above, measurement values can be binned into time periods in order to facilitate alignment. For example, measurement values can be binned in daily, weekly, monthly, quarterly, yearly, or other bins, such that any measurement falling within a particular range of time after the initial clinical visit are associated with a particular bin. If multiple measurements fall into the same bin, as noted above, these measurements can be combined into a single measurement value (e.g., by finding the median of the measurement values, finding the mean of the measurement values, or otherwise removing the additional measurement values). In this manner, although additional patient information may be acquired at any point in time after the initial clinical visit, patients' measurements corresponding to relatively similar points after each patient's initial clinical visit can be more conveniently aligned and compared.

After the data sets are aligned, a cluster center is selected for each cluster (step 320). As described above, each cluster center defines a particular classification value or collection of values for its respective cluster. Data sets have similar characteristics as each cluster center are thus assigned to the respective cluster. In some implementations, cluster centers can be selected based on pre-determined information (e.g., based on previously estimated cluster centers, assumed cluster centers, and so forth). In some implementations, cluster centers can be arbitrarily selected. In some implementations, cluster centers can be selected based on how many clusters are being used in the technique.

After cluster centers are selected, a similarity is determined between each data set and each cluster center (step 330). In some implementations, a similarity can be a parameter that defines how close each data set is to the cluster center, for example by summing the squared distances between each of point of the data set and its corresponding point of the cluster center. As noted above, data sets may be missing portions of information (e.g., missing measurement values from particular points or periods of time). In these cases, similarities can be determined based solely on a comparison between the available points of a data set and their corresponding points on the cluster centers. In this manner, data sets that are missing measurement values from particular points or periods of time are not necessarily determined to be less similar simply due to the unavailability of these measurements. Although determining a similarity based on a sum of squared distances is described above, this is merely an example. Other techniques for determining similarity can also be used, depending on the implementation.

After a similarity is determined between each data set and each cluster center, each data set is assigned to a particular cluster based on these similarities (step 340). In some implementations, data sets can be assigned to a particular cluster by identifying the cluster center that is most similar to that data set. For example, as described above, in some implementations, a similarity determined can be based on a sum of squared distances between the measurement values of a data set and the corresponding points of the cluster center. In this case, a data set might be assigned to a cluster by identifying the cluster center to which it has the shortest sum of squared distance. Again, although determining a similarity based on a sum of squared distances is described above, this is merely an example. Other techniques for determining similarity and finding an appropriate cluster can also be used, depending on the implementation.

After each data set is assigned to a cluster, it is determined if a stop criterion is met (step 350). As described above, the processing of clustering can be iterative, such that the data sets are clustered and re-clustered until a suitable result is found. A stop criterion can be used to evaluate the suitability of each intermediate result. As an example, in some implementations, a stop criterion can be a confidence metric that describes the statistical confidence that the intermediate result has been accurately determined. In some implementations, a metric can be used to describe the collective difference between each data set and the cluster center of the cluster to which the data set has been assigned (e.g., by determine the total distances of the data sets and corresponding cluster centers). In this case, the stop criterion can be a threshold value for this metric, such that the stop criterion is met when the metric meets or descends below the threshold value. In some cases, the stop criterion can be met when the metric has been minimized, indicating that the closest possible result has been found. Although various stop criteria are described above, these are merely illustrative examples. Other stop criteria can also be used, depending on the implementation. Further, in some cases, multiple stop criteria can also be used.

If the stop criterion is met, the process 300 ends, and clustering of the data sets is complete. In some implementations, when process 300 is used in conjunction with process 200, step 230 proceeds after the completion of process 300.

If the stop criterion is not met, the data sets are re-aligned and/or the cluster centers are reselected (step 360). As described above, the processing of clustering can be iterative, such that the data sets are clustered and re-clustered until a suitable result is found. Thus, one or more of the parameters of the model are altered in order to determine if a more accurate result can be found. As an example, a data set can be shifted, such that its first time point (t=0) shifts relative to the first time point of other data sets or cluster centers. Intuitively, shifting a data set forward in time corresponds to a condition where the first measurement value of the data set is shifted so that it is further in the progression of a disease; similarly, shifting a data set backwards in time corresponds to a condition where the first measurement value of the data set is shifted so that it is earlier in the progression of a disease. More than one data set can be shifted or re-aligned in this manner, depending on the implementation.

The cluster centers can also be reselected. For example, one or more of the reference measurement values of a cluster center can be modified (e.g., by increasing or decreasing the measurement value). In this manner, the pattern defined by each cluster center can be changed.

In some cases, only data sets are re-aligned. In other cases, only cluster centers are reselected. In still other cases, data sets are re-aligned and cluster centers are reselected. In practice, determining when to re-align data sets and/or reselect cluster centers can vary, depending on the implementation.

After the data sets are re-aligned and/or the cluster centers are reselected, steps 330 and 340 are repeated with the updated data sets and cluster centers. Steps 330, 340, 350, and 360 are thus repeated until the stop criterion is met, ending the process 300. In this manner, the data sets are iteratively re-aligned and/or the cluster centers are iteratively reselected until a suitable result is found.

As described above, implementations of the above described techniques can be used for a variety of applications. As an example application, this technique can be used to diagnose patients with respect to CKD based on patients' eGFR measurements over time.

In example below, the clusters of data are validated by association studies. Here, the population subtypes (cluster labels) are used in an association study where we ask whether a certain ICD9 disease diagnosis code is more common in a certain population subtype compared to the rest of the patients. We use Fisher's exact test and we run the association test between all disease subtype-ICD9 code pairs. When the association tests are run over 10000 ICD9 codes and 9 clusters, the Bonferroni multiple correction rate is p=10⁻⁷. Ordering the obtained p-value matrix by rows and columns gives information on what are the most distinctive subtypes and what are the most interesting disease diagnoses enriched in these subtypes. The maximum enrichment of selected relevant ICD9 codes can be used as a criterion for determining the optimal number of clusters. With K=9, a 100% enrichment of ICD9 code 585 (Chronic kidney disease) was found in one cluster. The same statistical testing procedure is used to study the enrichment of males and self-reported ethnicities in the clusters.

As patients have different numbers of data points available, a criterion is used for deciding which patients to include in the clustering analysis. In many cases, patients with zero or one eGFR measurements might not very useful in finding longitudinal trajectories; patients with two or three measurements might contain some information on the progression, but the measurements might be noisy and a large number of very short time-series may result in less coherent progression patterns. On the other hand, there may be a desirable to include as large a proportion of the available patients as possible in the analysis and the more stringent the selection criterion, the fewer patients fulfill it. We will compare the progression trajectories obtained by different selection criteria. The quantity to compare is the number of years from which patients have at least one data point available. The years do not need to be consecutive.

We construct a metric to evaluate the goodness of the learned trajectories. As differentiating disease progression rates between clusters is an important aspect of our modeling, we evaluate the difference of the eGFR slopes of individual trajectories compared to the slope of the cluster trajectory they have been assigned to. The slopes are calculated by fitting a regression line. Furthermore, as it turns out that some trajectories are non-linear and patients may have their available data from different parts of the non-linear trajectory, fitting a linear curve to a non-linear trajectory is this example not an optimal solution. We alleviate this problem by fitting a “local slope”, e.g., fitting the curve only to the part of the cluster trajectory from which the patient has data available and has been aligned to, and compare the individual slope to the local slope.

We demonstrate our technique on finding CKD progression subtypes from eGFR measurements. As previously described, and as shown in FIGS. 1A-B, only a small fraction of the total 27,985 patients in the example database have eGFR data from the full period of eleven years and very few have a full coverage of 44 quarter-yearly measurements that would correspond to fully observed dataset (e.g., having no missing values). As explained above, even such full coverage data might not be readily usable since patients might be in different phases of their disease progression and there are no clear start points. By using the clustering and alignment techniques described above, we can, however, use a significant portion of this heavily incomplete dataset.

We now evaluate how many eGFR measurements are required for patients to be included in the clustering as a tradeoff between patient attrition and model accuracy. In Table 1, we compare the criteria from how many years the patients need to have at least one measurement available (each year has been divided into four quarters). The number of available patients decreases with tighter criterion, with the benefit of better model accuracy. The slope error is the difference of the slope of an individual trajectory compared to the slope of the cluster trajectory. The accuracy of the model is defined above.

TABLE 1
Sample size and median error for different number of years

| Selection criterion (Years) | 2 | 3 | 4 | 5 |
|---|---|---|---|---|
| Number of patients with | 17672 | 13558 | 10539 | 8117 |
| data available | | | | |
| Median slope error | 1.66 | 1.35 | 1.24 | 1.18 |

As can be seen from Table 1, the number of patients with a sufficient amount of data available to meet the inclusion criterion drops rapidly when tightening the criterion. In the same time, the accuracy of the model increases, as there are a smaller number of short, inaccurate time-series worsening the clustering result. We choose to include patients with eGFR measurement from at least 4 different years. Using this selection, we get very coherent progression subtypes yet have a large number of patients (10539) available.

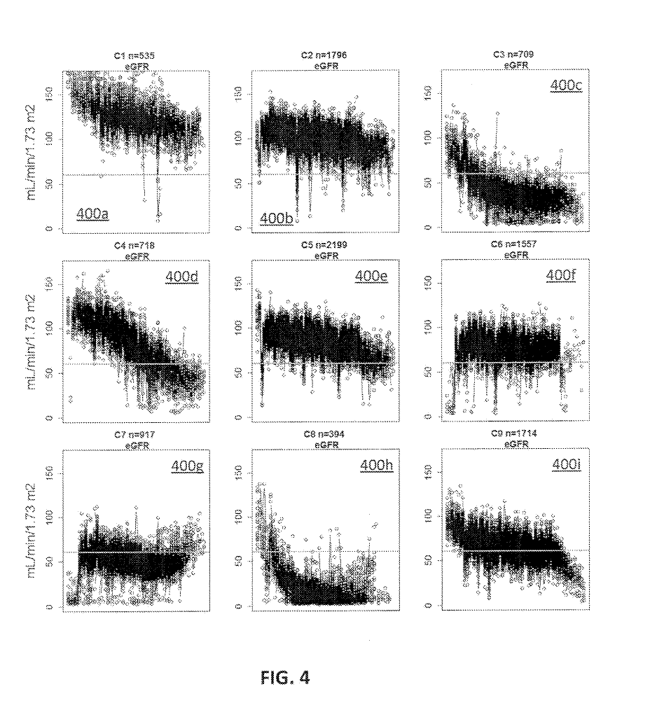

The results of clustering is shown in FIG. 4. FIG. 4 shows that many distinct coherent eGFR progression patterns can be found from the 10539 patients that represent the entire patient cohort. FIG. 4 shows clustering and alignment results for eGFR using 9 clusters; each cluster in the figure consists of eGFR trajectories of all the patients in that cluster that have been aligned together (as shown in plots 400a-i). These trajectories have highly varying lengths and varying numbers of missing values. The time span corresponds to 16 years; each patient has data from 4-11 years (up to 44 quarter-yearly time points) and 20 possible start points are allowed. The n indicates the number of patients in each cluster; C indicates the cluster number.

As shown in FIG. 4, the eGFR progression patterns for 9 clusters represent the entire patient subcohort with at least 4 years of eGFR data. We have chosen 9 as the number of clusters as we have empirically observed it to be the minimum number that finds all the clinically meaningful main progression patterns and at least one cluster (C8, lowest eGRF values) with 100% enrichment of the ICD9 code 585 (Chronic kidney disease). As can be seen from FIG. 4, there is considerable noise in the data since eGFR measurements are inherently noisy and the trajectories from 10539 patients have been forced to 9 clusters. This noise could be reduced by using yearly medians instead of quarterly medians (with the cost of clinically important time resolution); even more coherent clusters could be sought by increasing the number of clusters.

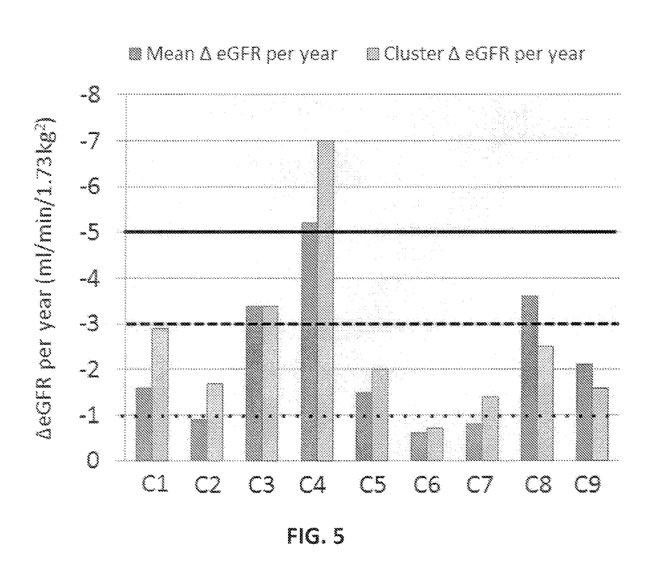

In Table 2, we demonstrate the median and interquartile range of the first and last time points of the eGFR of patients in each cluster, the mean duration (years) of data available, and the average slope of progression. Columns 4-7 show the values of the first and last points of the cluster trajectories (cluster centers) and the slope that has been fitted to the cluster trajectories. The values are in accordance with one another and with FIG. 4. Note that the median of the first values of the individual trajectories is different from the first point of the cluster trajectory since the patients in a cluster have their first time point (first visit to the clinic) at varying stages of the cluster trajectory (this also applies to the last time points). The accordance of the slopes of individual trajectories in a cluster with cluster trajectories is further visualized in FIG. 5. In FIG. 5 shows a bar graph of mean of eGFR change (AeGFR) per year (dark grey) and cluster center AeGFR (light grey) for patients in clusters C1 to C9. Lines indicate usual thresholds for nonprogression (dotted line), moderate progression (dashed line), and rapid progression (solid line).

TABLE 2
Summary of the eGFR progression patterns

| | | Median | Median | | Clus- | Clus- | |
|---|---|---|---|---|---|---|---|
| | Mean | first | last | Av- | ter | ter | Clus- |
| | yrs | eGFR | eGFR | erage | first | last | ter |
| | (SD) | [IQR] | [IQR] | slope | eGFR | eGFR | slope |
| C1 | 7.5(2.3) | 127.6[18.1] | 120.3[17.1] | −1.6 | 142.9 | 86.9 | −2.9 |
| C2 | 7.6(2.4) | 105.7[13.4] | 98.7[14.8] | −0.9 | 105.9 | 91.2 | −1.7 |
| C3 | 6.9(2.5) | 50.3[28.1] | 33.2[15.7] | −3.4 | 78.1 | 31.4 | −3.4 |
| C4 | 6.4(2.6) | 108.0[18.0] | 76.9[38.3] | −5.2 | 118.2 | 43.2 | −7 |
| C5 | 6.9(2.6) | 93.8[12.4] | 83.9[15.6] | −1.5 | 94.5 | 63.7 | −2 |
| C6 | 6.5(2.6) | 80.9[14.4] | 77.5[12.6] | −0.6 | 79.6 | 73.4 | −0.7 |
| C7 | 6.9(2.7) | 58.2[15.8] | 50.3[12.4] | −0.8 | 50.5 | 47.8 | −1.4 |
| C8 | 6.5(2.4) | 26.9[31.9] | 9.9[8.6] | −3.6 | 51.8 | 13.7 | −2.5 |
| C9 | 6.9(2.64) | 74.2[16.4] | 62.4[13.4] | −2.1 | 89.2 | 41.2 | −1.6 |

In order to assess the clinical applicability and relevance of this clustering method, we hypothesized that demographic and disease patterns that were seen in longitudinal studies with similar patterns of eGFR progression would replicate independently in these clusters. In Table 3, we show the mean and standard deviation of age, percentage of males and self-reported ethnicities (European ancestry (EA), African ancestry (AA), Hispanic/Latino (HL), Others) in each cluster. The star denotes clusters were the enrichment of a certain ancestry or gender was statistically significantly higher than for all the other patients using Fisher's exact test (Bonferroni rate p=10⁻⁴). Each cluster had a statistically significantly different mean age compared to the patients in the other clusters using t-tests.

TABLE 3
Demographic characteristics of clusters, of all the patients
in the analysis and all the patients in the database

| | Age | Males | EA | AA | HL | Other |
|---|---|---|---|---|---|---|
| | [Sd] | (%) | (%) | (%) | (%) | (%) |
| C1 | 36.9[10.7]* | 32 | 5.5 | 59.3* | 32.1 | 3.1 |
| C2 | 50.1[10.6]* | 36 | 13.1 | 34.3* | 46 | 6.6 |
| C3 | 71.7[12.2]* | 40 | 24.4 | 28 | 42 | 5.6 |
| C4 | 49.7[13.3]* | 32 | 14.1 | 44.3* | 34.1 | 7.5 |
| C5 | 57.8[11.0]* | 37 | 22 | 26.1 | 44.9 | 7 |
| C6 | 62.5[11.6]* | 40 | 28.6* | 22.4 | 42.2 | 6.9 |
| C7 | 70.3[11.7]* | 40 | 26.3* | 25.3 | 41.6 | 6.8 |
| C8 | 62.9[13.9]* | 52* | 14.9 | 40.7* | 36.4 | 8 |
| C9 | 66.1[11.1]* | 37 | 25.3* | 25 | 42.8 | 6.9 |
| All | 59.1[14.4] | 38 | 21 | 30.2 | 42.1 | 6.7 |
| All in | 53.7[17.2] | 41 | 30.8 | 24.3 | 35.3 | 9.6 |
| Database | | | | | | |

Table 4 shows the percentage of patients in each cluster with a diagnosis of selected ICD9 codes (or a more specific ICD9 code in the same hierarchy). The star denotes clusters were the enrichment of ICD9 codes is statistically significantly high compared to all patients in the other clusters (pooled). The Bonferroni multiple correction rate is p=10⁻⁷.

TABLE 4
Distribution of ICD9 codes among clusters, of all the patients
in the analysis and all the patients in the database.

| | | C1 | C2 | C3 | C4 | C5 | C6 | C7 | C8 | C9 | All | Database |
|---|---|---|---|---|---|---|---|---|---|---|---|---|
| 585.xx | CHRONIC | 1 | 2 | 89* | 21 | 4 | 6 | 55* | 100* | 21 | 21 | 12 |
| | KIDNEY | | | | | | | | | | | |
| | DISEASE (CKD) | | | | | | | | | | | |
| | (%) | | | | | | | | | | | |
| 585.6 | END STAGE | 0 | 0 | 14* | 2 | 0 | 1 | 7 | 77* | 1 | 5 | 2 |
| | RENAL | | | | | | | | | | | |
| | DISEASE (%) | | | | | | | | | | | |
| v45.1x | RENAL | 0 | 0 | 6 | 1 | 0 | 0 | 3 | 64* | 0 | 3 | 1 |
| | DIALYSIS | | | | | | | | | | | |
| | STATUS (%) | | | | | | | | | | | |
| 403.xx | HYPERTENSIVE | 0 | 1 | 67* | 14 | 2 | 3 | 35* | 93* | 13 | 15 | 8 |
| | CHRONIC | | | | | | | | | | | |
| | KIDNEY | | | | | | | | | | | |
| | DISEASE (%) | | | | | | | | | | | |
| 401.xx | ESSENTIAL | 43 | 62 | 95* | 63 | 70 | 72 | 88* | 97* | 81* | 73 | 52 |
| | HYPERTENSION | | | | | | | | | | | |
| | (%) | | | | | | | | | | | |
| 250.xx | DIABETES | 31 | 36 | 65* | 45 | 39 | 38 | 55* | 65* | 44 | 43 | 28 |
| | MELLITUS (%) | | | | | | | | | | | |
| 410.xx | ACUTE | 1 | 2 | 12* | 4 | 3 | 4 | 8 | 19* | 6 | 5 | 3 |
| | MYOCARDIAL | | | | | | | | | | | |
| | INFARCTION | | | | | | | | | | | |
| | (%) | | | | | | | | | | | |
| 414.xx | CHRONIC | 5 | 12 | 53* | 20 | 18 | 22 | 41* | 68* | 31 | 25 | 20 |
| | ISCHEMIC | | | | | | | | | | | |
| | HEART | | | | | | | | | | | |
| | DISEASE (%) | | | | | | | | | | | |
| 428.xx | HEART | 8 | 9 | 41* | 18 | 10 | 10 | 28* | 60* | 18 | 17 | 10 |
| | FAILURE (%) | | | | | | | | | | | |
| 584.xx | ACUTE KIDNEY | 3 | 5 | 58* | 22 | 5 | 8 | 30* | 67* | 17 | 16 | 8 |
| | FAILURE (%) | | | | | | | | | | | |
| 285.xx | OTHER AND | 43 | 38 | 73* | 42 | 31 | 30 | 50 | 92* | 41 | 42 | 24 |
| | UNSPECIFIED | | | | | | | | | | | |
| | ANEMIAS (%) | | | | | | | | | | | |

These demographics and ICD9 codes present an independent clinical validation of the relevance and applicability for the clustering patterns. For example: cluster 1 represents a group of patients that start at a high eGFR with the median eGFR being more than 120 ml/min/1.73m2. Clinically, this represents a group of patients who have glomerular hyperfiltration (a precursor to developing kidney injury with elevated eGFR above 120 ml/min/1.73m2) which usually happens in younger patients who are usually African-American and occurs in the very early stages of diabetes mellitus and hypertension and thus might not have a confirmed diagnosis of them. As demonstrated in Tables 3 and 4, patients in cluster 1 are significantly younger than those in other clusters with a mean age of 36.9 years and have a lower prevalence of diabetes mellitus and hypertension as compared to the other clusters.

Clusters 3 and 8 provide more evidence for this validation. As shown in FIG. 4, these are clusters where patients starting from a CKD stage 3/4 with a mean eGFR of 50 and 27 ml/min/1.73m2 progress rapidly to a low eGFR (mean eGFR of 33 and 10 ml/min/1.73m2 respectively). These clusters have the highest prevalence of an ICD9 code for acute kidney injury (AKI), heart failure and anemia amongst the clusters. As shown in multiple studies, AKI, heart failure and anemia are very significant risk factors for both CKD progression and end stage renal disease (ESRD) development. This is further validated within these clusters since cluster 8 that has a higher prevalence of acute kidney injury, heart failure and anemia compared to cluster 3, also has a higher proportion of ESRD and dialysis and a lower final eGFR. Cluster 2 is an example of healthy patients with normal eGFR and they do not have many CKD diagnoses.

Thus we demonstrate that an example implementation of this technique organizes sparse and non-aligned data into coherent and clinically meaningful subtypes based on disease progression and this finds further independent validation after comparing demographics and ICD9 code enrichment.

In this disclosure, we have demonstrated the use of clustering and alignment modeling for finding disease progression subtypes from highly incomplete EMR laboratory data. We have shown that using this type of modeling, we can use a large portion of a longitudinal dataset that has irregular time series of varying lengths and a high proportion of missing data. In particular, we have shown how to deal with the fact that there are no clear initial time points in the time-series; the solution is to align similar trajectories together. As an illustrative example, our technique was successful in finding from the data meaningful CKD progression patterns that correspond to known disease subtypes and stages.

The generative Bayesian modeling formalism is a flexible approach that allows for the construction of models that take into account all the necessary aspects of the modeling problem. In our case, clustering longitudinal data, alignment and dealing with missing data could all be done within a single unified model. We also successfully validated our clusters by association studies between the clusters, demographics and ICD9 diagnosis codes.

There are many potential applications for this approach. For instance, although novel genetic associations with eGFR have been reported, there are other potential genetic associations that explain the differential rates of CKD in different ethnic populations. However most genetic association studies are cross-sectional in nature and longitudinal studies require the resources of clinical cohorts. This clustering approach could be applied to evaluating genetic associations with longitudinal disease progression especially in institutions which have EMR linked databases. This is of special importance with national consortia such as the Electronic Medical Records and Genomics (eMERGE) Network a NHGRI funded consortium tasked with developing methods and best-practices for the utilization of the Electronic Medical Record (EMR) as a tool for genomic research. Also, since this approach can be deployed at multiple sites with EMR, a large number of patients can be used for modeling purposes that would not be possible in conventional longitudinal cohort studies.

In the example above, we considered the clustering of only one longitudinal variable. However, in some implementations, our model can be directly used for multiple variables. Implementations of this technique can, for instance, cluster and align longitudinal eGFR, SBP and hemoglobin A1C data together in order to find clusters with similar progression in multiple variables. Adding more variables and increasing the number of clusters in the analysis can lead to discovering ever more specific clinical subtypes, critical in the future direction of personalized treatment decision support.

As an example, implementations of the technique can be used to analyze data sets that have longitudinal data from eGFR and hemoglobin A1C (a marker for diabetes) and five cross-sectional variables: age, gender, last BMI measurement, variability of SBP over time (standard deviation) and mean SBP over time. In this example, the technique searches clusters that have similar progression patterns in all the longitudinal variables and similar values of the cross-sectional variables. In this example, we have made the extension to include cross-sectional variables because there are often useful additional demographic and other variables available and integrating them in the analysis is often meaningful. We have run the method on a large number of clusters (K=40), but we show here only six manually chosen interesting clusters that best illustrate the potential of our modeling approach. To validate our clusters, we have run statistical tests of association between the clusters and ICD9 codes.

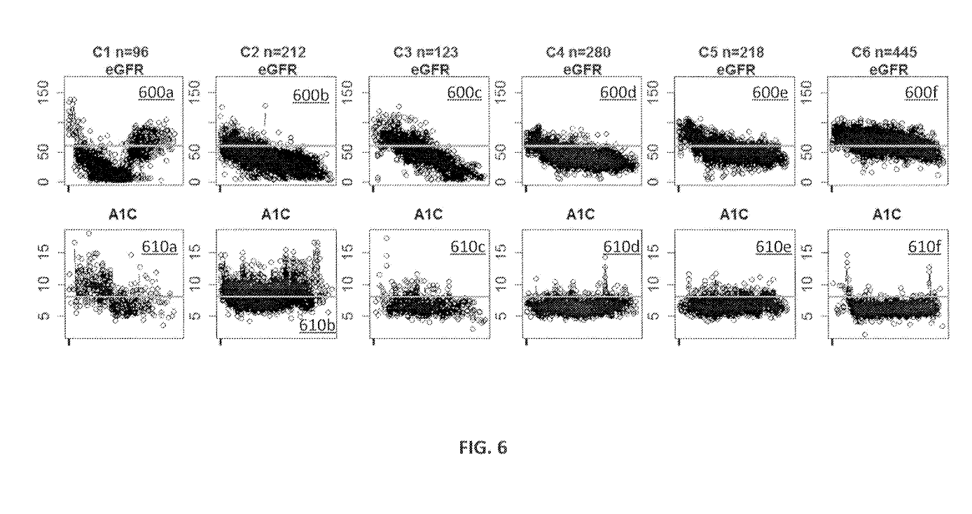

As CKD is caused either by diabetes and/or hypertension, we attempt to show differential progression patterns in multiple variables. There is also considerable interest towards finding and comparing rapid and slow CKD progression rates and we examine how our method can contribute to this research question. The progression patterns of eGFR and A1C and the mean values of the cross-sectional variables are shown in FIG. 6, where plots 600a-f and plots 610a-f show eGFR and A1C measurements for six clusters respectively. As can be seen from this example, many distinct coherent progression patterns can be found from longitudinal eGFR and A1C data integrated with 5 cross-sectional variables that were used jointly in finding the clusters. FIG. 6 and Table 5 show clustering and alignment results for 6 clusters together with the mean values (cluster centers) of the 5 cross-sectional variables in each cluster. The eGFR is a measure of kidney functioning. The threshold for CKD onset is eGFR<60 and when it reaches zero, death usually follows. eGFR also decreases with age. A1C>8 is a diagnosis threshold for diabetes. The red lines show these diagnosis thresholds. SBP>140 indicates hypertension; normal range is SBP<120. The n indicates the number of patients in each cluster.

TABLE 5
Summary of patient distribution patterns.

| | C1 | C2 | C3 | C4 | C5 | C6 |
|---|---|---|---|---|---|---|
| Age | 54.4 | 72.3 | 66.7 | 79.8 | 68.4 | 73.1 |
| % Males | 73.1 | 28.8 | 41.6 | 0.4 | 4.7 | 0.1 |
| BMI | 27.6 | 31.7 | 29.6 | 26.3 | 39.7 | 29.4 |
| SBP variability (std) | 16.5 | 15 | 27 | 13.6 | 12.3 | 12.1 |
| SMP mean | 139.2 | 139.8 | 153.4 | 134.4 | 130.6 | 133.3 |

In this example, cluster 1 represents CKD patients that have rapidly progressed into end stage. However, half of the patients have received a kidney transplant and their status is improving. The patients are hypertensive and some also have diabetes. The association studies with ICD9 codes (Table 6) support these finding as the patients have heavy enrichment of End stage renal disease, Renal dialysis status, Kidney replaced by transplant and Hypertensive chronic kidney disease. Patients in cluster 2 are in slightly earlier phase of CKD progression, but the figure clearly shows they progress rapidly. The patients are hypertensive and highly diabetic with uncontrolled A1C; both factors are known to cause rapid progression of CKD. The ICD9 codes support these findings. Cluster 3 also represents rapid progression of CKD. These patients are extremely hypertensive, however, they are considerably less diabetic. This suggests that in this cluster, the progression of CKD is primarily run by hypertension.

Clusters 4 and 5 represent slower progression where many (but not all) have already reached CKD status. Cluster 4 represents very old patients with moderate hypertension, and limited signs of diabetes. Cluster 5 represents highly obese patients with diabetic manifestations but a moderate blood pressure. Cluster 6 represents patients who are slowly progressing towards CKD, although few have yet reached CKD status. The patients have moderate hypertension but few diabetic manifestations.

TABLE 6
Distribution of ICD9 codes among clusters,
of all the patients in the analysis.

| | | C1 | C2 | C3 | C4 | C5 | C6 |
|---|---|---|---|---|---|---|---|
| 585 | CHRONIC KIDNEY | 99 | 92 | 63 | 65 | 53 | |
| | DISEASE (CKD) | | | | | | |
| 585.6 | END STAGE RENAL DISEASE | 79 | 18 | | | | |
| v45.1 | RENAL DIALYSIS STATUS | 61 | | | | | |
| v42.0 | KIDNEY REPLACED BY | 47 | | | | | |
| | TRANSPLANT | | | | | | |
| 403 | HYPERTENSIVE CHRONIC | 94 | 76 | 46 | 42 | 32 | |
| | KIDNEY DISEASE | | | | | | |
| 585.3 | CHRONIC KIDNEY DISEASE | | 70 | 33 | 49 | 32 | |
| | STAGE III (MODERATE) | | | | | | |
| 250 | DIABETES MELLITUS | | 90 | | | 73 | |
| 584 | ACUTE KIDNEY FAILURE | 76 | 58 | 40 | 39 | 33 | |
| 278 | OVERWEIGHT OBESITY | | | | | 77 | |
| | AND OTHER | | | | | | |
| | HYPERALIMENTATION | | | | | | |

Finally, though we used CKD as an example the opportunities for examining distinct disease progression subtypes and making innovative discoveries are endless in any disease area depending on available data in the EMR.

Some implementations of subject matter and operations described in this specification can be implemented in digital electronic circuitry, or in computer software, firmware, or hardware, including the structures disclosed in this specification and their structural equivalents, or in combinations of one or more of them. For example, in some implementations, medical (e.g., EMRs) can be stored, maintained, revised, and/or retrieved using a system implemented using digital electronic circuitry, or in computer software, firmware, or hardware, or in combinations of one or more of them. In another example, processes 200 and 300 can be implemented using digital electronic circuitry, or in computer software, firmware, or hardware, or in combinations of one or more of them.

Some implementations described in this specification can be implemented as one or more groups or modules of digital electronic circuitry, computer software, firmware, or hardware, or in combinations of one or more of them. Although different modules can be used, each module need not be distinct, and multiple modules can be implemented on the same digital electronic circuitry, computer software, firmware, or hardware, or combination thereof.

Some implementations described in this specification can be implemented as one or more computer programs, i.e., one or more modules of computer program instructions, encoded on computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer may also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices (e.g., EPROM, EEPROM, flash memory devices, and others), magnetic disks (e.g., internal hard disks, removable disks, and others), magneto optical disks, and CD ROM and DVD-ROM disks. The processor and the memory can be supplemented by, or incorporated in, special purpose logic circuitry.

To provide for interaction with a user, operations can be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A computer system may include a single computing device, or multiple computers that operate in proximity or generally remote from each other and typically interact through a communication network. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). A relationship of client and server may arise by virtue of computer programs running on the respective computers and having a client-server relationship to each other.

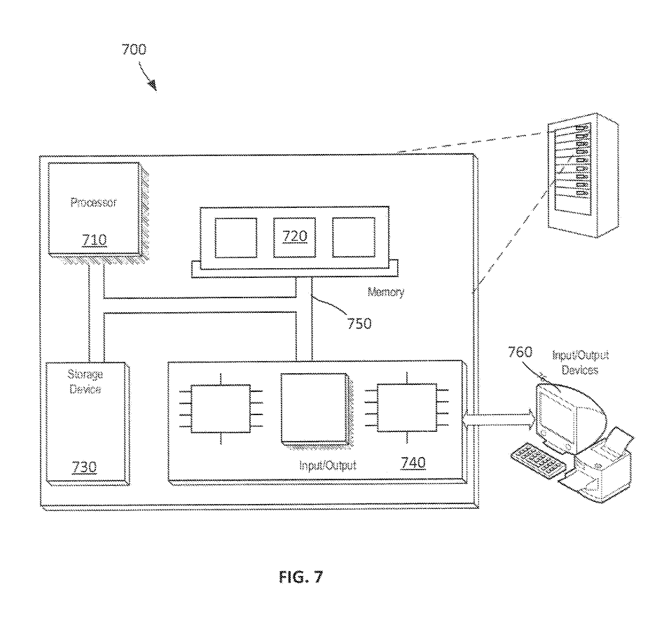

FIG. 7 shows an example computer system 700. The system 700 includes a processor 710, a memory 720, a storage device 730, and an input/output device 740. Each of the components 710, 720, 730, and 740 can be interconnected, for example, using a system bus 750. The processor 710 is capable of processing instructions for execution within the system 700. In some implementations, the processor 710 is a single-threaded processor, a multi-threaded processor, or another type of processor. The processor 710 is capable of processing instructions stored in the memory 720 or on the storage device 730. The memory 720 and the storage device 730 can store information within the system 700.

The input/output device 740 provides input/output operations for the system 700. In some implementations, the input/output device 740 can include one or more of a network interface devices, e.g., an Ethernet card, a serial communication device, e.g., an RS-232 port, and/or a wireless interface device, e.g., an 802.11 card, a 3G wireless modem, a 4G wireless modem, etc. In some implementations, the input/output device can include driver devices configured to receive input data and send output data to other input/output devices, e.g., keyboard, printer and display devices 760. In some implementations, mobile computing devices, mobile communication devices, and other devices can be used.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

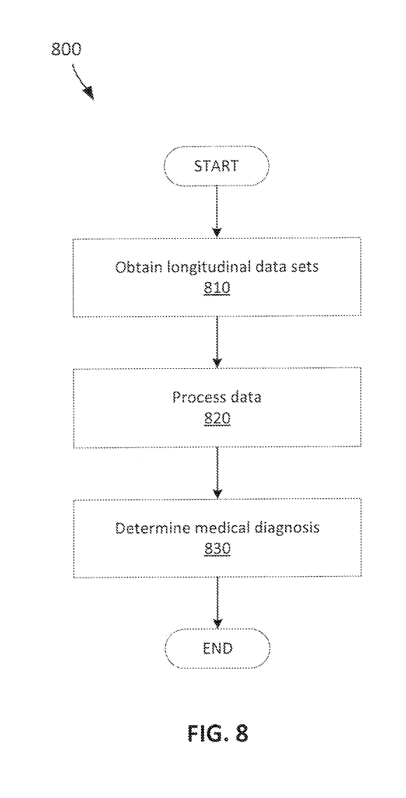

For instance, an example process 800 for making an automated medical diagnosis using a computer system 700 is shown in FIG. 8. Process 800 begins by obtaining longitudinal data sets for each of several patients (step 810). Step 810 can be similar to step 210, as described above. In an example implementation, the computer system 700 can obtain data sets maintained on the computer system 700 (e.g., within the memory 720 and/or the storage device 730), or in one or more other computer systems communicatively connected to the computer 700 (e.g., a client computer, a server computer, a group of computers, and so forth). For instance, the computer system 700 can electronically request and receive data sets maintained on a server computer through a communications network.

After the data sets are obtained, the medical record is processed by the computer system 700 (step 820). Processing can include one or more of the steps and the arrangement of steps shown in FIGS. 2 and 3. In an example implementation, the computer system 700 can parse the medical record in search of particular data fields, data flags, or data values that might indicate information that can be used to render a diagnosis. For instance, the computer system 700 might search for known data fields that contain particular measurement values and corresponding time points, demographic information regarding the patient, medical history information regarding the patient, and other such information. In some cases, information in the data sets can be arranged in a manner that facilitates processing by computer system 700. For example, various conditions, disease, procedures, measurement values, and so forth can be represented by alphanumeric or binary codes, such that computer system 700 can readily parse the data sets in search of particular codes. The results of this processing can be stored in the data sets itself (e.g., as a “summary” data field), or it can be stored separate from the medical record (e.g., as a separate file or data object).

As noted above, processing can include one or more of the steps shown in FIGS. 2 and 3. For example, the computer system 700 can manipulate the information contained within the data sets in order to arrange the data sets into two or more clusters. In a similar manner as described with respect to FIG. 3, arranging the data sets can include aligning by aligning the data sets according to time point, selecting a cluster center for each cluster, determining a similarity between each data set and each cluster center, and assigning each data set to a particular cluster based on the similarities. In addition, the computer system 700 can iteratively re-align one or more of the data sets and/or reselecting one or more cluster centers, determine an updated similarity between each data set and each cluster center, and re-assign data sets to particular clusters based on the updated similarities until a stop criterion is met. For example, the computer system 700 can maintain a data object that contains the intermediate result from each iteration of the processing step. As the processing step is iterated, the data object can be updated to include to reflect the updated results. These results can be stored, for example, within the memory 720 and/or the storage device 730.

After the computer system 700 completes processing the data sets, the computer system 700 renders a diagnosis (step 830). Determining which diagnosis to render can be performed in a similar manner as shown in FIG. 2. For example, depending on the results of processing the data sets, a particular diagnosis can be made regarding a particular patient associated with one of the data sets. The computer system 700 can make this determination, for example, by referring to the medical record (e.g., the “summary” data field of the medical record) or to a separate file or data object containing the results of the processing, and using a logic table or decision tree that defines when render each possible certain diagnosis.

The results of process 800 can be output to a user (e.g., a clinician or technician) though an appropriate output device (e.g., input/output devices 760). The results of process 700 can also be record in the patient's medical record. For example, the computer system 700 can revise the patient's medical record to include the results of process 800, then store the medical record for future retrieval. For example, the computer system 700 can update the patient's medical record, then store the medical record in memory 720 and/or storage device 730, or transmit it to another computer system (e.g., a client computer, a server computer, a group of computers, and so forth) via a communications network for storage.

In some implementations, the computer system 700 can be a dedicated system that solely performs process 800. In some implementations, the computer system 700 can also perform other tasks that are related and/or unrelated to process 800.

A number of implementations have been described. Nevertheless, it will be understood that various modifications may be made without departing from the spirit and scope of the invention. Accordingly, other implementations are within the scope of the following claims.

What is claimed is:

1. A method of automated medical diagnosis, the method comprising:
obtaining an electronic longitudinal data set for each of a plurality of patients, wherein each data set comprises:
a plurality of measurement values corresponding to a metric, wherein each measurement value is associated with a respective time point,
arranging the data sets into two or more clusters, wherein arranging the data sets comprises:
aligning the data sets according to their respective time points;
selecting a cluster center for each cluster;
determining a similarity between each data set and each cluster center;
assigning each data set to a particular cluster based on the similarities; and
iteratively re-aligning one or more of the data sets and/or reselecting one or more cluster centers, determining an updated similarity between each data set and each cluster center, and re-assigning data sets to particular clusters based on the updated similarities until a stop criterion is met; and
automatically determining a medical diagnosis for a patient based on a relationship between the patient's data set and a cluster center.

2. The method of claim 1, wherein at least one of the data sets has a different number of measurement values than other data sets.

3. The method of claim 1, wherein each cluster center comprises a plurality of reference values, each measurement value associated with a respective reference time point.

4. The method of claim 3, wherein determining a similarity between each data set and each cluster center comprises determining similarities between measurement values of each data set to corresponding reference values of each cluster center.

5. The method of claim 1, wherein the stop criterion comprises a threshold value associated with the similarity determination.

6. The method of claim 1, wherein aligning the data sets according to their respective time points comprises aligning the data sets such that a first measurement value of each data set is aligned according to a common time point.

7. The method of claim 1, wherein re-aligning one or more of the data sets comprises shifting the time points of the one or more data sets relative to the time points of one or more other data sets.

8. The method of claim 1, wherein the measurement values correspond to a biological metric of a particular patient.

9. The method of claim 1, wherein each measurement value corresponds to an estimated glomerular filtration rate of a particular patient at a particular point in time.

10. The method of claim 1, wherein the medical diagnosis comprises a predicted disease state.

11. The method of claim 10, wherein the disease state is chronic kidney disease.

12. A system for diagnosing chronic kidney disease (CKD), the system comprising:
a computing apparatus configured to:
obtain an electronic longitudinal data set for each of a plurality of patients, wherein each data set comprises:
a plurality of measurement values corresponding to a metric, wherein each measurement value is associated with a respective time point,
arrange the data sets into two or more clusters, wherein arranging the data sets comprises:
aligning the data sets according to their respective time points;
selecting a cluster center for each cluster;
determining a similarity between each data set and each cluster center;
assigning each data set to a particular cluster based on the similarities; and
iteratively re-aligning one or more of the data sets and/or reselecting one or more cluster centers, determining an updated similarity between each data set and each cluster center, and re-assigning data sets to particular clusters based on the updated similarities until a stop criterion is met; and
automatically determine a medical diagnosis for a patient based on a relationship between the patient's data set and a cluster center.

13. The system of claim 12, wherein at least one of the data sets has a different number of measurement values than other data sets.

14. The system of claim 12, wherein each cluster center comprises a plurality of reference values, each measurement value associated with a respective reference time point.

15. The system of claim 14, wherein determining a similarity between each data set and each cluster center comprises determining similarities between measurement values of each data set to corresponding reference values of each cluster center.

16. The system of claim 12, wherein the stop criterion comprises a threshold value associated with the similarity determination.

17. The system of claim 12, wherein aligning the data sets according to their respective time points comprises aligning the data sets such that a first measurement value of each data set is aligned according to a common time point.

18. The system of claim 12, wherein re-aligning one or more of the data sets comprises shifting the time points of the one or more data sets relative to the time points of one or more other data sets.

19. The system of claim 12, wherein the measurement values correspond to a biological metric of a particular patient.

20. The system of claim 12, wherein each measurement value corresponds to an estimated glomerular filtration rate of a particular patient at a particular point in time.

21. The system of claim 12, wherein the medical diagnosis comprises a predicted disease state.

22. The system of claim 21, wherein the disease state is chronic kidney disease.

23. A non-transitory computer readable medium storing instructions that are operable when executed by a data processing apparatus to perform operations for determining a permeability of a subterranean formation, the operations comprising:
obtaining an electronic longitudinal data set for each of a plurality of patients, wherein each data set comprises:
a plurality of measurement values corresponding to a metric, wherein each measurement value is associated with a respective time point,
arranging the data sets into two or more clusters, wherein arranging the data sets comprises:
aligning the data sets according to their respective time points;
selecting a cluster center for each cluster;
determining a similarity between each data set and each cluster center;
assigning each data set to a particular cluster based on the similarities; and
iteratively re-aligning one or more of the data sets and/or reselecting one or more cluster centers, determining an updated similarity between each data set and each cluster center, and re-assigning data sets to particular clusters based on the updated similarities until a stop criterion is met; and
automatically determining a medical diagnosis for a patient based on a relationship between the patient's data set and a cluster center.

24. The non-transitory computer readable medium of claim 23, wherein at least one of the data sets has a different number of measurement values than other data sets.

25. The non-transitory computer readable medium of claim 23, wherein each cluster center comprises a plurality of reference values, each measurement value associated with a respective reference time point.

26. The non-transitory computer readable medium of claim 25, wherein determining a similarity between each data set and each cluster center comprises determining similarities between measurement values of each data set to corresponding reference values of each cluster center.

27. The non-transitory computer readable medium of claim 23, wherein the stop criterion comprises a threshold value associated with the similarity determination.

28. The non-transitory computer readable medium of claim 23, wherein aligning the data sets according to their respective time points comprises aligning the data sets such that a first measurement value of each data set is aligned according to a common time point.

29. The non-transitory computer readable medium of claim 23, wherein re-aligning one or more of the data sets comprises shifting the time points of the one or more data sets relative to the time points of one or more other data sets.

30. The non-transitory computer readable medium of claim 23, wherein the measurement values correspond to a biological metric of a particular patient.

31. The non-transitory computer readable medium of claim 23, wherein each measurement value corresponds to an estimated glomerular filtration rate of a particular patient at a particular point in time.

32. The non-transitory computer readable medium of claim 23, wherein the medical diagnosis comprises a predicted disease state.

33. The non-transitory computer readable medium of claim 32, wherein the disease state is chronic kidney disease.
